(19) United States
(12) Patent Application Publication
(10) Pub. No.: US 2024/0412260 A1
(43) Pub. Date: Dec. 12, 2024

(54) INFORMATION PROCESSING SYSTEM

(71) Applicant: Toyota Jidosha Kabushiki Kaisha, Toyota-shi (JP)

(72) Inventors: Naoki YAMADA, Kasugai-shi (JP); Makoto MATSUSHITA, Ichinomiya-shi (JP); Yuko MIZUNO, Nagoya-shi (JP); Hayato MIZUMA, Tokyo (JP); Kohei MIWA, Sunto-gun (JP)

(73) Assignee: Toyota Jidosha Kabushiki Kaisha, Toyota-shi (JP)

(21) Appl. No.: 18/648,757

(22) Filed: Apr. 29, 2024

(30) Foreign Application Priority Data
Jun. 7, 2023 (JP) 2023-094298

(51) Int. Cl. G06Q 30/02; G06Q 30/0645; G06V 10/40; G06V 20/59

(52) U.S. Cl. CPC G06Q 30/0278; G06Q 30/0645; G06V 10/40; G06V 20/59

(57) ABSTRACT

An information processing system that performs information processing related to a car sharing service includes an in-vehicle camera installed in a vehicle provided for a car sharing service, and a server that calculates an evaluation value related to handling of the vehicle by a user of the car sharing service based on a video inside the vehicle captured by the in-vehicle camera.

### CROSS-REFERENCE TO RELATED APPLICATION

This application claims priority to Japanese Patent Application No. 2023-094298 filed on Jun. 7, 2023, incorporated herein by reference in its entirety.

### BACKGROUND

### 1. Technical Field

The present disclosure relates to information processing systems that process information to be used in a car sharing service.

### 2. Description of Related Art

Japanese Unexamined Patent Application Publication No. 2020-86656 (JP 2020-86656 A) describes an information processing system that is used for a ride-sharing service. A ride-sharing service is a service for notifying a driver of any passenger who has the same departure point or destination as the driver and wishes to share a ride with the driver. The information processing system evaluates the level of satisfaction of each user based on a video of the user captured during the shared ride. The system then reflects the evaluation results in rideshare matching.

### SUMMARY

Evaluation of users is sometimes also required for car sharing services. However, proper user evaluation has not been possible due to lack of objective evaluation criteria.

An information processing system that solves the above problem includes: an imaging device installed in a vehicle that is used for a car sharing service; and a calculation unit configured to calculate an evaluation value regarding handling of the vehicle by a user of the car sharing service based on a video inside the vehicle captured by the imaging device.

The information processing system advantageously allows objective evaluation of users of a car sharing service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an embodiment of an information processing system; and

FIG. 2 is a flowchart of processing executed by a server in the information processing system.

### DETAILED DESCRIPTION OF EMBODIMENTS

### Configuration of Information Processing System

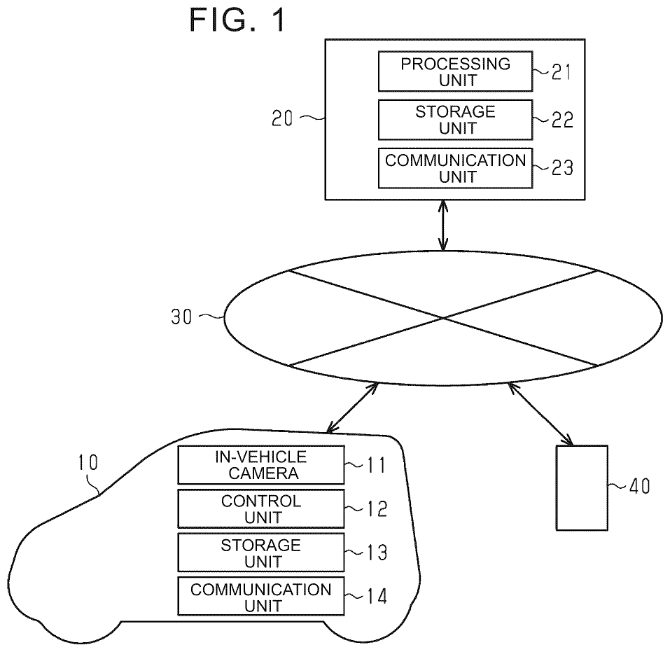

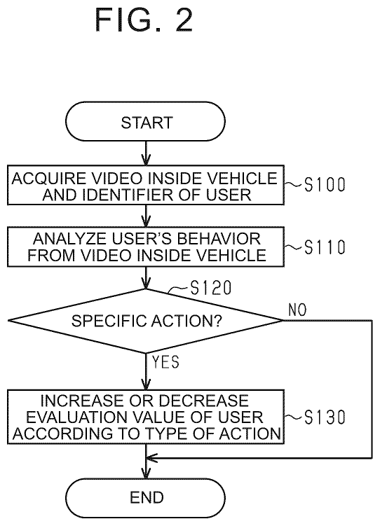

Hereinafter, an embodiment of an information processing system will be described in detail with reference to FIGS. 1 and 2. First, a configuration of an information processing system according to the present embodiment will be described with reference to FIG. 1. The information processing system of the present embodiment is configured as a system that performs information processing related to evaluation of a user of a car sharing service. The information processing system of the present embodiment includes a vehicle 10 provided for a car sharing service and a server 20. Here, the description will be given on the assumption that a car sharing service in which a company that manages and offers the vehicle 10 provides the user with the vehicle 10 arranged at a station provided in each place. In this case, a business operator providing the vehicle 10 is an owner of the vehicle 10, and the user is a renter of the vehicle 10.

In the vehicle 10, an in-vehicle camera 11, which is an imaging device that captures a video inside the vehicle, is installed. The vehicle 10 includes a control unit 12, a storage unit 13, and a communication unit 14. The control unit 12 is an electronic control unit that controls the in-vehicle camera 11, processes a video captured by the in-vehicle camera 11, and the like. The storage unit 13 is a storage medium that stores to be programs executed by the control unit 12, videos captured by the in-vehicle camera 11, and the like. The communication unit 14 includes a communication module that connects the vehicle 10 to be able to communicate with the network 30 outside the vehicle.

The server 20 includes a processing unit 21, a storage unit 22, and a communication unit 23. The processing unit 21 includes a processor that executes various processes related to the car sharing service. The storage unit 22 stores a program of processing executed by the processing unit 21 and various data for a car sharing service. The communication unit 23 includes a communication module for connecting to the network 30. The storage unit 22 of the server 20 includes a database for storing information of the vehicle 10 and the user. The database stores, as information of the user, an evaluation value related to the handling of the vehicle 10 of the user in a manner linked to the identifier of the user.

Each vehicle 10 to be shared is communicably connected to the server 20 via the network 30. Further, the server 20 is communicably connected to the mobile terminal 40 of the user via the network 30. An application program for using the car sharing service is installed in the mobile terminal 40 of the user. The user accesses the server 20 through the application program to find, reserve, and unlock the vehicle 10 he or she is going to rent.

### Evaluation of Users

The information processing system according to the present embodiment performs evaluation regarding the handling of the vehicle 10 by the user of the car sharing service. FIG. 2 shows a flow of processing performed by the server 20 for this evaluation.

Such evaluations are conducted on the condition that consent of the user has been obtained. Specifically, when renting the vehicle 10, the application program inquires of the user whether to consent to capturing a video inside the vehicle for evaluation of the user in the mobile terminal 40. Then, the server 20 executes the processing of FIG. 2 on condition that the user has given consent to capturing a video inside the vehicle.

As illustrated in FIG. 2, in the present process, the server 20 first acquires, in S100, a video captured by the in-vehicle camera 11 during the use of the vehicle 10 together with the identifier of the user. The video may be acquired by sequentially transmitting a video captured by the in-vehicle camera 11 to the server 20 during the use of the vehicle 10. Alternatively, the video may be acquired by temporarily storing a video captured by the in-vehicle camera 11 in the storage unit 13 of the vehicle 10 and transmitting the video to the server 20 at a time after the use of the vehicle 10 or the like.

Next, in S110, the server 20 analyzes the behavior of the user inside the vehicle from the acquired video. Then, in S120, the server 20 determines whether the user has performed a particular action set as an evaluation item based on the analysis result. Specific actions include, for example, eating and drinking in a car, smoking, rough or careful manipulation of vehicle equipment such as doors, and interior cleaning. In the present embodiment, eating and drinking and smoking cessation in the vehicle and coarse operation of the vehicle equipment are an undesirable action that lowers the user's evaluation of the handling of the vehicle 10. On the other hand, the careful operation of the vehicle equipment and interior cleaning are preferable actions for improving the evaluation of the user regarding the handling of the vehicle 10.

When a particular action is confirmed (S120: YES), the server 20 operates the evaluation value of the user according to the type of the action (S130). Specifically, the server 20 increases or decreases the evaluation value of the user by a value set in advance for each type of action. A default initial value is set as the evaluation value of the user at the time of registration of the car sharing service. In the case of the present embodiment, the evaluation value is set as a value indicating that the user's evaluation regarding the handling of the vehicle 10 is higher as the value is larger. Then, the server 20 operates on the side of decreasing the evaluation value of the user when the confirmed specific action is a type set as an unfavorable action. On the other hand, when the confirmed specific action is the type set as the preferred action, the server 20 operates on the side of increasing the evaluation value of the user. The increase/decrease width of the evaluation value may be uniform regardless of the type of the action or may be different depending on the type of the action. When a specific action is confirmed a plurality of times during use of the vehicle 10, the server 20 operates the evaluation value for each action. In the information processing system of the present embodiment, the server 20 corresponds to a calculation unit that calculates an evaluation value of a user related to the handling of the vehicle 10.

### Operation and Effect of Embodiments

The operation and effects of the present embodiment will be described. In the information processing system of the present embodiment, the server 20 calculates an evaluation value related to handling of the vehicle 10 by the user of the car sharing service based on the video inside the vehicle captured by the in-vehicle camera 11 installed in the vehicle 10. The calculated evaluation values of the respective users are stored in a database constructed in the storage unit 22 of the server 20.

According to the information processing system of the present embodiment, the following effects can be obtained.

(1) The information processing system of the present embodiment includes an in-vehicle camera 11 installed in a vehicle 10 provided for a car sharing service, and a server 20. The server 20 calculates an evaluation value related to handling of the vehicle 10 by the user of the car sharing service based on the video inside the vehicle captured by the in-vehicle camera 11. Therefore, it is possible to objectively evaluate the user of the car sharing service.

(2) The server 20 confirms whether the user has performed a specific action in the vehicle by analyzing the video from the in-vehicle camera 11. Then, the server 20 calculates the evaluation value by increasing or decreasing the value according to the type of the confirmed action. As a result, the evaluation value can be calculated as a value reflecting the action of the user in the vehicle.

### Use of Evaluation Values

The evaluation value of the user to be calculated in the information processing system can be used, for example, in the following applications.

It is conceivable that a merchant providing the vehicle 10 provides an incentive, such as a discount, to a user who carefully handles the vehicle 10. In such a case, the evaluation value of the user calculated by the information processing system can be used as a criterion for giving an incentive.

In some cases, the owner of the vehicle 10 determines whether to allow the renter to rent the vehicle 10 when the owner receives from the renter a request to rent the vehicle 10. In such a case, the evaluation value of the user who has requested to rent the vehicle 10 is presented to the owner. As a result, the evaluation value of the user calculated by the information processing system can be used as a criterion for determining whether to allow the user to rent the vehicle.

Car sharing may be provided as a service for matching the owner and renter of the vehicle 10. In this case, both the owner and renter of the vehicle 10 are users of the car sharing service. In such a case, when the renter who wishes to rent the vehicle 10 selects a vehicle 10 to rent, the evaluation value of the owner is presented to the renter. Thus, the evaluation value of the user calculated by the information processing system can be used as a criterion for evaluating the condition of the vehicle 10 at the time of selecting a vehicle 10 to rent, for example, cleanliness inside the vehicle.

### Other Embodiments

The present embodiment can be modified as follows. The present embodiment and the following modifications can be implemented in combination with each other as long as they are not technically contradictory.

### Calculation Unit

The control unit 12 of the vehicle 10 analyzes the behavior of the user based on the video captured by the in-vehicle camera 11, and transmits the analysis result from the vehicle 10 to the server 20. Then, the server 20 calculates the evaluation value of the user based on the received analysis result. In this case, both the control unit 12 and the server 20 of the vehicle 10 constitute a calculation unit. In this case, after the analysis by the control unit 12 is completed, the data of the video inside the vehicle used for the analysis may be deleted.

Only the control unit 12 of the vehicle 10 may calculate the evaluation value of the user based on the video inside the vehicle and transmit the calculation result to the server 20. In this case, the control unit 12 of the vehicle 10 corresponds to the calculation unit.

### Period of Capturing Video Inside Vehicle Etc.

In the above embodiment, a video inside the vehicle to be used for the calculation of the evaluation value is captured throughout the use of the vehicle 10, but the video capturing period may be limited. For example, a car sharing service provider may recommend or require interior cleaning when returning a vehicle. In such a case, a video inside the vehicle to be used for calculation of the evaluation value may be captured only during interior cleaning after use of the vehicle 10. The calculation of the evaluation value in this case can be performed by, for example, determining from the video inside the vehicle during interior cleaning whether the user actually cleaned the interior of the vehicle and increasing or decreasing the evaluation value based on the determination result.

In the above embodiment, the video inside the vehicle to be used for calculation of the evaluation value is captured on condition that consent of the user has been obtained. For example, the video inside the vehicle to be used for calculation of the evaluation value may be captured without confirming consent in the following cases: when the user is not allowed to rent the vehicle 10 unless he or she gives consent, and when consent of the user is obtained when the user is registered with the service.

What is claimed is:

1. An information processing system comprising:
an imaging device installed in a vehicle that is used for a car sharing service; and
a calculation unit configured to calculate an evaluation value regarding handling of the vehicle by a user of the car sharing service based on a video inside the vehicle captured by the imaging device.

2. The information processing system according to claim 1, wherein the evaluation value is used to present an evaluation of a renter who wishes to rent the vehicle when an owner of the vehicle determines whether to allow the renter to rent the vehicle.

3. The information processing system according to claim 1, wherein the evaluation value is used to present an evaluation of the vehicle when a renter who wishes to rent the vehicle selects a vehicle to rent.

4. The information processing system according to claim 1, wherein the video to be used to calculate the evaluation value is captured on condition that consent of the user has been obtained.

5. The information processing system according to claim 1, wherein a video during interior cleaning after use of the vehicle is used as the vehicle.
